(19) United States
(12) Patent Application Publication
(10) Pub. No.: US 2016/0033369 A1
(43) Pub. Date: Feb. 4, 2016

(54) MONITORING OF A FIRST EQUIPMENT OF A FIRST TECHNICAL INSTALLATION USING BENCHMARKING

(71) Applicant: SIEMENS AKTIENGESELLCHAFT, München (DE)

(72) Inventors: MARTIN LEHOFER, Plainsboro, NJ (US); GÜNTHER WINTER, Neunkirchen/Brand (DE)

(73) Assignee: SIEMENS AKTIENGESELLCHAFT, München (DE)

(21) Appl. No.: 14/774,926

(22) PCT Filed: Feb. 7, 2014
(86) PCT No.: PCT/EP2014/052389

§ 371 Date: Sep. 11, 2015

(30) Foreign Application Priority Data
Mar. 12, 2013 (EP) 13158713.1

(51) Int. Cl. G01M 99/00; G06F 17/30

(52) U.S. Cl. CPC G01M 99/005; G06F 17/3053

(57) ABSTRACT

In situations where first equipment of a first technical installation could hitherto not be monitored based on condition data of the first equipment from the first equipment alone, it is proposed that a first sensor measures first condition data of the first equipment and that art additional sensor measures additional condition data of an additional equipment of an additional technical installation. The first condition data and the additional condition data are transmitted to a sorting unit and processed by the sorting unit into a ranking list. A corresponding sorting unit and a system as well as a corresponding computer program and a computer program product are also disclosed.

The invention relates to a method for monitoring a first item of equipment of a first technical installation. The invention further relates to a sorting unit, a system, a computer program and a computer program product for monitoring a first item of equipment of a first technical installation.

For certain component parts or items of equipment of industrial installations there are no practical methods for predicting failures or for determining how long they will remain operable. If changes occur on an item of equipment, such as vibrations or noises, repair measures are possibly carried out. The success of said repair measures, far example in the form of reduced vibrations or reduced noises, cannot however be assessed objectively. In such cases it is not possible to pursue condition-based maintenance by means of condition monitoring because no information is present regarding parameterization or setting of limits.

Items of equipment for which condition-based monitoring or maintenance solely on the basis of data for the equipment to be monitored has hitherto not been possible are encountered for example in the context of rolling mills with roll stands. In this situation such installations can have many individual parts, each subject to wear, and overall have a complex structure which means that the approach employing condition-based monitoring for example of a roll stand is accompanied by a large number of physical observables. It may therefore not be possible to deduce an unambiguous relationship between the observables and the condition, for example of the roll stand.

With regard to such component parts or items of equipment, the maintenance is therefore performed on a preventive basis, for example after a certain period of operation or after a certain volume of material has been produced, or on suspicion, for example in the case of unusual behavior, such as vibrations or noises.

From U.S. Pat. No. 6,643,801 B1 a method for the estimation of a time until the next machine fault is known which is based on a database in which fault data from a plurality of machines and repair data for said machines are entered.

The object of the invention is to enable monitoring of the first item of equipment even if monitoring has hitherto not been possible solely on the basis of condition data for the first item of equipment.

This object is achieved by a method for monitoring a first item of equipment of a first technical installation, wherein a first sensor detects first condition data for the first item of equipment and a further sensor detects further condition data for a further item of equipment of a further technical installation, wherein the first condition data and the further condition data are transmitted to a sorting unit and wherein the first condition data and the further condition data are processed into a ranking list by the sorting unit.

This object is further achieved by a sorting unit for monitoring a first item of equipment of a first technical installation, wherein the sorting unit comprises reception means for receiving first condition data for the first item of equipment and further condition data for a further item of equipment of a further technical installation and also a computing unit for processing the first condition data and the further condition data into a ranking list.

This object is further achieved by a system for monitoring a first item of equipment of a first technical installation, wherein the system comprises a first sensor for detecting first condition data for the first item of equipment, a further sensor for detecting further condition data for a further item of equipment of a further technical installation, and the sorting unit according to the invention.

This object is finally achieved by a computer program as claimed in claim 11 and a computer program product as claimed in claim 12.

Provided for monitoring the first item of equipment are a first sensor which detects first condition data for the first item of equipment and also a further sensor which detects further condition data for a further item of equipment of a further technical installation. In this situation, the respective sensor detects for example a temperature, vibrations, information relating to position and/or speed, lubricant quality or temperature, optical data or the like in respect of the respective item of equipment.

The detected condition data are transmitted to a sorting unit which produces a ranking list therefrom. In this situation the sorting unit, in particular in the form of a computer or other computing unit, can for example be operated by an external service provider and the monitoring of the first item of equipment or of the first installation can be offered as a service to the operator of the respective installation. For example, the first condition data and/or the further condition data can be transmitted continuously or cyclically and/or automatically or manually. In this situation, for transmission of the respective condition data the first sensor and/or the second sensor can be connected directly to the sorting unit or for example by way of a packet-based network, such as for example the internet, a private network or a virtual private network. In this situation, a unit for data processing which for example carries out a preprocessing of the respective condition data can additionally be provided between the respective sensor and the sorting unit. In particular, the transmission of the respective condition data can be carried out in parallel for a plurality of items of equipment of the same or similar kind of a plurality of technical installations of a plurality of different operators.

The sorting unit receives the transmitted first condition data and further condition data and undertakes for example continuous or cyclical processing of condition data received in order to produce the ranking list.

In this situation the method according to the invention offers particular advantages for a first item of equipment for which no method hitherto existed in order to assess in particular on the basis of the first condition data when a replacement or maintenance of the first item of equipment is required or when a failure of the first item of equipment is to be expected. This is because condition-based monitoring or maintenance can also take place according to the invention for a first item of equipment for which no exact limit values have hitherto been specified or for which no methods for determining exact limit values have hitherto been available. In particular, this means that the success of repair measures can be better assessed because the position of the first item of equipment changes in the ranking list after a repair of the first item of equipment has been effected.

In this situation it is not necessary that the operator of the first item of equipment grants the service provider direct access to his system. Rather, the operator of the first item of equipment can himself specify which data are forwarded. The operator thereby profits indirectly from the fact that other operators participate in the method according to the invention in the form of “crowd-sourcing” but without disclosing sensitive business information. In this situation the service provider is able to gather information by processing and storing the data obtained in order to derive and to specify limit values therefrom or to identify a behavior of the respective item of equipment. In principle it is also possible to operate condition monitoring for the respective item of equipment in isolation, in other words without access to more detailed information from other operators.

Since the monitoring of the first item of equipment is carried out on the basis of the first condition data and the further condition data, it is possible to state in this connection that benchmarking is implemented.

In an advantageous embodiment of the invention the ranking list is created by comparing the first condition data with the further condition data.

The comparison can be based for example on the absolute values of the first condition data and the further condition data. For example, it is possible in each case to consider the largest absolute values of the respective condition data. It is also conceivable that “outliers” are ignored and merely the second largest or third largest absolute values are taken into consideration.

Provision can likewise be made that the comparison is based on at least one statistically or stochastically derived variable which is derived from the first condition data and the further condition data. The variables derived in such a manner include for example the arithmetic or geometric mean, the median, the standard deviation and the like.

It is moreover conceivable that mathematical functions relating to the description of the first condition data and the further condition data are derived on the basis of said first condition data and said further condition data, for example by performing a linear regression or a fit to a mathematical function. The comparison could then be performed on the basis of parameters of the respective mathematical function.

In an advantageous embodiment of the invention the ranking list and/or the rank of the first condition data in the ranking list are transmitted to a data processing unit of the first item of equipment and/or of the first technical installation.

In particular, if the sorting unit is operated by an external service provider it can be advantageous for data protection reasons to merely transmit the rank of the first condition data in the ranking list to the data processing unit or to the first technical installation and thereby make said rank available to the operator of the first technical installation. This in turn ensures that no unauthorized access can take place to sensitive data for the respective technical installation which may in particular be operated by a competitor.

The transmitted ranking list or the transmitted rank of the first condition data in the ranking list here enables the data processing unit or the technical installation to take measures in order to improve the rank of the first item of equipment in the ranking list. The objective of improving the rank in this situation is in particular to avoid any material, financial or other damage or a failure or downtime of the first item of equipment. it is thus possible in the event of an unfavorable rank of the first condition data to provide for maintenance or an inspection of the first item of equipment.

Furthermore, in order to transmit the respective condition data the first sensor and/or the second sensor can in the first instance be connected to the data processing unit which transmits the respective condition data, where applicable after any preprocessing of the respective condition data, to the sorting unit.

The data processing unit can for example be embodied as a controller of the first item of equipment and/or of the first technical installation. It is similarly conceivable that the data processing unit is embodied as a condition monitoring system, IT system or automation system of the first item of equipment and/or of the first technical installation. The condition monitoring system in question is preferably an integrated condition monitoring system which is integrated into an IT system or automation system.

In an advantageous embodiment of the invention a report is created if the first condition data have a less favorable rank than the further condition data in the ranking list.

The format of the report can in particular be customized to specific output media, for example a hardcopy printout on paper, a display on a screen of a PC or mobile device, or sending by email or via SMS and the like. It is for example possible to access the report “remotely” by way of a computer network, in other words from a distance for example by way of the internet and/or by using mobile devices. Furthermore, the report can for example be sent to a person responsible for the first item of equipment.

Creation of the report and in particular sending the report thereby make it possible to take measures in order to improve the rank of the first item of equipment in the ranking list, whereby damage can in turn be averted and a failure or downtime of the first item of equipment can be prevented.

In an advantageous embodiment of the invention the first condition data and/or the further condition data are compressed prior to transmission to the sorting unit.

The compression can for example be achieved by means of analysis functions, such as for example a Fourier analysis of the respective condition data. If the compression is performed decentrally in the respective technical installation, a rapid transmission of the respective condition data to the sorting unit is thereby enabled because the data volume to be transferred can be appreciably reduced as a result of the compression. For example, the compression can be performed by the above-mentioned data processing unit of the first item of equipment or of the first technical installation.

In an advantageous embodiment of the invention the first condition data, the first condition data and the further condition data and/or the ranking list are stored in a storage unit of the sorting unit, wherein first repair data relating to a repair of the first item of equipment and/or of the first technical installation and further repair data relating to a repair of the further item of equipment and/or of the further technical installation are transmitted to the sorting unit and stored in the storage unit of the sorting unit, in which case the first condition data, the first condition data and the further condition data and/or the rank of the respective condition data are correlated with the respective repair data and the correlation is used to determine whether a repair of the first item of equipment and/or of the first technical installation is necessary.

The respective repair data can for example comprise information relating to the point in time of the execution of the repair of the respective item of equipment or installation and information relating to the extent of the repair performed. This may for example include details on which part of the respective item of equipment has been replaced or repaired, how severely damaged or worn the repaired or replaced part was or the like.

In this situation the concept of the repair and the repair data can also be defined more broadly and include maintenance and repair measures for the respective item of equipment. The corresponding repair data can in particular include the point in time of the execution of the respective measures and information relating to the wear of the respective item of equipment.

The correlation can in particular be determined between the first condition data and the first repair data. It is also conceivable to determine the correlation between the first condition data and the further condition data on the one hand and the first repair data and the further repair data on the other hand. Furthermore, a determination of the correlation between the rank of the respective condition data and the respective repair data is possible. Finally, the determination of a correlation between all the aforementioned data is also conceivable.

If condition data are used for the correlation, then it is for example possible to take into consideration the lubricant quality or temperature together with the time intervals between two repair measures. The correlation can in particular be configured such that a value is found for the first condition data in the form of a certain lubricant quality or temperature or a rank of the respective condition data under which conditions it was hitherto always possible to operate the respective item of equipment reliably. Given a knowledge of the current first condition data or of the rank of the first condition data in the ranking list it is thereby possible to determine whether a repair of the first item of equipment or of the first installation is currently necessary.

Particularly meaningful and reliable results can then be obtained particularly when a relatively large number of items of equipment or installations which are similar or of a similar type make available their condition data and are monitored in such a manner.

In an advantageous embodiment of the invention, on the basis of the ranking list and repair data stored in the storage unit of the sorting unit, in this situation a condition of the first item of equipment and/or of the first technical installation is identified and/or a limit value as of which a repair of the first item of equipment and/or the first technical installation is necessary is ascertained for the first condition data.

On the basis of the correlation, in particular a limit value can be ascertained for the first condition data, for which limit value it was necessary in the past on a number of occasions or always to carry out repair work on the first item of equipment or an item of equipment comparable with the first item of equipment.

The correlation can also be used in order to identify a condition of the first item of equipment which renders necessary a repair of the first item of equipment and/or the first technical installation. Such a condition can for example be an unbalanced rotating part, a damaged bearing or an inadequate lubricant quality, which can be detected and identified thanks to the correlation.

In an advantageous embodiment of the invention, the correlation is used in this situation to determine when a repair of the first item of equipment and/or the first technical installation is necessary.

Should no repair of the first item of equipment yet be necessary at the current time, then it is possible on the basis of the correlation for example to ascertain a trend or a mathematical function which describes the behavior hitherto and where applicable the future behavior of the first item of equipment and a statement can be made, for example by means of an interpolation, relating to future first condition data to be expected. If the future first condition data or the rank of the first condition data is compared with a value at which it was previously always possible to operate the respective item of equipment reliably, then it is possible to estimate the time remaining until the next repair of the first item of equipment or to estimate the point in time when the next repair of the first item of equipment will be necessary. To this end, in particular the future first condition data or the rank of the first condition data can be compared with the aforementioned limit value.

It is generally also possible to provide a plurality of sensors per item of equipment in the case of the present invention. The first technical installation and the further technical installation can also be identical and have two or more items of equipment which are similar or of a similar type, in which case at least one sensor in each case detects the condition data for the respective item of equipment.

The respective item of equipment or the respective technical installation can for example be embodied as a rolling mill, roll stand or part of a rolling mill or roll stand.

The invention will be described and explained in detail in the following with reference to the exemplary embodiment illustrated in the figure. In the drawing:

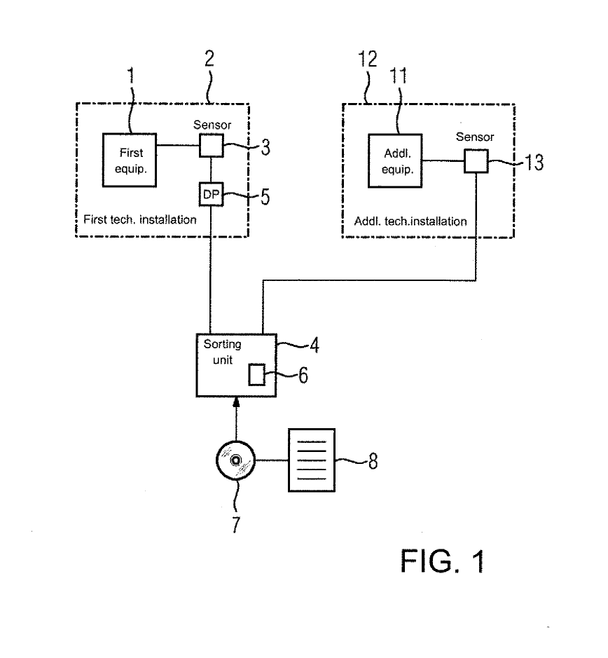

FIG. 1 shows an exemplary embodiment of a system according to the invention for monitoring a first item of equipment of a first technical installation.

FIG. 1 shows an exemplary embodiment of a system according to the invention for monitoring a first item of equipment 1 of a first technical installation 2. In this situation the first technical installation 2 has a first sensor 3 which detects first condition data for the first item of equipment 1. A further technical installation 12 is furthermore provided with a further item of equipment 11 and a further sensor 13 for detecting further condition data for the further equipment 11.

The first technical installation 2 furthermore has a data processing unit 5 for the first item of equipment 1, wherein the first sensor 3 is connected to the data processing unit 5. The data processing unit 5 can for example be embodied as an integrated condition monitoring system which carries out preprocessing of the first condition data, for example in the form of a compression. The data processing unit 5 is connected to a sorting unit 4, to which it transmits the first condition data, preprocessed where applicable. Alternatively, the first sensor 3 can also be connected directly to the sorting unit 4. A connection of the data processing unit 5 to the first item of equipment 1 can also be provided.

For transmission of the further condition data the further sensor 13 is connected to the sorting unit 4, in which case the further technical installation 12 can alternatively also have a further data processing unit which is connected both to the further sensor 13 and also to the sorting unit 4.

The connection for transmission of the respective condition data to the sorting unit 4 can in this situation be implemented in cable-free fashion, for example using wireless or WLAN, or cabled fashion, for example optical fiber, using LAN, the internet or a private network. In this situation the sorting unit 4 processes the first condition data and the further condition data into a ranking list. The respective condition data can here in particular be compressed in the respective technical installation before they are transmitted to the sorting unit 4. The compression of the first condition data can for example be performed by the data processing unit 5.

The sorting unit 4 has a storage unit 6, in which for example the first condition data, the further condition data and/or the ranking list can be stored. In order to process the condition data into a ranking list the sorting unit 4 executes a computer program 8 which is stored on a computer program product 7, such as for example a CD or a USB stick, and which is read in by the sorting unit 4.

The sorting unit 4 can furthermore comprise reception means (not illustrated) for receiving the first condition data and the further condition data and also a computing unit (not illustrated) for processing the first condition data and the further condition data into a ranking list. In particular, the sorting unit 4 can transmit the ranking list and/or the rank of the first condition data in the ranking list to the data processing unit 5.

To summarize, the invention relates to a method for monitoring a first item of equipment of a first technical installation. The invention further relates to a sorting unit, a system, a computer program and a computer program product for monitoring a first item of equipment of a first technical installation. In order to enable monitoring of the first item of equipment even if monitoring has hitherto not been possible solely on the basis of condition data for the first item of equipment, it is proposed that a first sensor detects first condition data for the first item of equipment and a further sensor detects further condition data for a further item of equipment of a further technical installation, wherein the first condition data and the further condition data are transmitted to a sorting unit and where the first condition data and the further condition data are processed into a ranking list by the sorting unit.

1.-12. (canceled)

13. A method for monitoring a first item of equipment of a first technical installation, comprising:
with a first sensor, detecting first condition data for the first item of equipment,
with an additional sensor, detecting additional condition data for an additional item of equipment of an additional technical installation,
transmitting the first condition data and the additional condition data to a sorting unit, and
with the sorting unit, processing the first condition data and the additional condition data into a ranking list.

14. The method of claim 13, wherein the ranking list is created by comparing the first condition data with the additional condition data.

15. The method of claim 13, wherein at least one of the ranking list and a rank of the first condition data in the ranking list is transmitted to a data processing unit of the first item of equipment or of the first technical installation, or both.

16. The method of claim 13, further comprising creating a report when the first condition data have a less favorable rank than the additional condition data in the ranking list.

17. The method of claim 13, further comprising compressing at least one of the first condition data and the additional condition data prior to transmission to the sorting unit.

18. The method of claim 13, further comprising
storing at least one item selected from the first condition data, the first condition data together with the additional condition data, and the ranking list in a storage unit of the sorting unit,
transmitting first repair data relating to a repair of the first item of equipment or of the first technical installation, or both, and transmitting additional repair data relating to a repair of the additional equipment or of the additional technical installation, or both to the sorting unit and storing the first repair data and the additional repair data in the storage unit of the sorting unit,
correlating at least one item selected from the first condition data, the first condition data together with the additional condition data and a rank of the first and additional condition data with the respective first and additional repair data, and
determining based on the correlation whether at least one of the first item of equipment and the first technical installation requires a repair.

19. The method of claim 18, further comprising
identifying based on the ranking list and the first and additional repair data stored in the storage unit of the sorting unit a condition of at least one of the first item of equipment and of the first technical installation, or
determining for the first condition data a limit value that indicates whether a repair of at least one of the first item of equipment and the first technical installation is necessary.

20. The method of claim 18, further comprising
determining based on the correlation when a repair of at least one of the first item of equipment and the first technical installation is required.

21. A sorting unit for monitoring a first item of equipment of a first technical installation, comprising
an interface receiving first condition data for the first item of equipment and additional condition data for an additional item of equipment of an additional technical installation, and
a computing unit configured to process the first condition data and the additional condition data into a ranking list.

22. A system for monitoring a first item of equipment of a first technical installation, comprising
a first sensor for detecting first condition data for the first item of equipment,
an additional sensor for detecting additional condition data of an additional item of equipment of an additional technical installation, and
a sorting unit comprising
an interface receiving the first condition data for the first item of equipment and the additional condition data for an additional item of equipment of the additional technical installation, and
a computing unit configured to process the first condition data and the additional condition data into a ranking list.

23. A computer program comprising program code embodied on a non-transitory computer-readable medium, wherein the computer program, when loaded into a memory of a sorting unit and executed by the sorting unit, causes the sorting unit to:
receive first condition data of a first item of equipment of a first technical installation measured by a first sensor,
receive additional condition data of an additional item of equipment of an additional technical installation measured by an additional sensor, and
process the first condition data and the additional condition data into a ranking list.

24. A computer program product embodied on a non-transitory computer-readable medium and comprising computer program code, wherein the computer program code, when loaded into a memory of a sorting unit and executed by the sorting unit, causes the sorting unit to:
receive first condition data of a first item of equipment of a first technical installation measured by a first sensor,
receive additional condition data of an additional item of equipment of an additional technical installation measured by an additional sensor, and
process the first condition data and the additional condition data into a ranking list.
